(19) United States
(12) Patent Application Publication
(10) Pub. No.: US 2015/0310788 A1
(43) Pub. Date: Oct. 29, 2015

(54) DISPLAY DEVICE AND METHOD FOR CONTROLLING THE SAME

(71) Applicant: LG ELECTRONICS INC., Seoul (KR)

(72) Inventors: Sihwa PARK, Seoul (KR); Jihwan KIM, Seoul (KR); Doyoung LEE, Seoul (KR); Eunhyung CHO, Seoul (KR); Sinae CHUN, Seoul (KR)

(21) Appl. No.: 14/331,738

(22) Filed: Jul. 15, 2014

(30) Foreign Application Priority Data
Apr. 24, 2014 (KR) 10-2014-0049195

(51) Int. Cl. G09G 3/20; G06F 3/01; G06F 3/041

(52) U.S. Cl. CPC G09G 3/20; G06F 3/0412; G06F 3/014; G06F 3/015; G06F 3/016; G06F 2203/04106; G06F 2203/04104; G06F 2203/04101; G06F 2203/011; G09G 2354/00

(57) ABSTRACT

A display device is disclosed. The display device includes a sensor unit configured to sense an input to the display device, a display unit configured to display an image, a communication unit configured to perform communication with an external device, and a processor configured to control the sensor unit, the display unit and the communication unit, wherein the processor detects a touch input of a first input state to the display unit, the first input state being a touch input state detected with the external device worn on a user's body, detects content displayed by the external device worn on the user's body, the content being displayed at a plurality of executing levels, detects that the displayed content is first content displayed at a first executing level, receives, from the external device, second content using the communication unit, the second content being displayed at a lower executing level of the first executing level, and displays the received second content on the display unit.

This application claims the benefit of Korean Patent Application No. 10-2014-0049195, filed on Apr. 24, 2014, which is hereby incorporated by reference as if fully set forth herein.

### BACKGROUND OF THE INVENTION

1. Field of the Invention

The present disclosure relates to a display device and a method for controlling the same.

2. Discussion of the Related Art

With development of technologies, development of wearable devices has been accelerated. Herein, the wearable device represent devices wearable on a body like clothes, watches, glasses, and accessories. Since the wearable device worn on the user's body, it may be readily accessible and carried by the user. On the other hand, such display devices as a smartphone and a tablet computer may be conveniently used by means of, for example, fingers or a touch pen, but they may need to be inconveniently carried in a pocket or a bag or in hand.

The wearable devices need to be small and light since they are worn on the body. Accordingly, the screen provided to the wearable device may be small. Accordingly, it may be difficult for the user to secure a sufficient view of the content displayed on a display unit provided to the wearable device and to apply a touch input to the display unit. Accordingly, in the case that the user views content or applies a touch input to the display unit, using a large digital device with a relatively large screen may be convenient although portability and accessibility thereof is low.

To this end, the user may pair the display device with a wearable device to allow the display device to mirror the content displayed on the wearable device. In this case, however, the display device simply copy and display the screen of the wearable, and the two devices may not be used to display the content at various executing levels.

### SUMMARY OF THE INVENTION

Accordingly, the present disclosure is directed to a display device and a method for controlling the same which substantially obviate one or more problems due to limitations and disadvantages of the related art

An object of the present disclosure is to provide a display device configured to detect the state of a touch input according whether or not an external device is worn, and a method for controlling the same.

Another object of the present disclosure is to provide a display device configured to display content of a lower executing level for the content being provided by an external device, and a method for controlling the same.

Another object of the present disclosure is to provide a display device configured to detect whether a detected touch input is a touch input by the right hand or by the left hand, and a method for controlling the same.

Another object of the present disclosure is to provide a display device configured to display a content group as content of a lower executing level, and a method for controlling the same.

A further object of the present disclosure is to provide a display device configured to display a content editing interface as content of a lower executing level, and a method for controlling the same.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a display device includes a sensor unit configured to sense an input to the display device, a display unit configured to display an image, a communication unit configured to perform communication with an external device, and a processor configured to control the sensor unit, the display unit and the communication unit, wherein the processor detects a touch input of a first input state to the display unit, the first input state being a touch input state detected with the external device worn on a user's body, detects content displayed by the external device worn on the user's body, the content being displayed at a plurality of executing levels, detects that the displayed content is first content displayed at a first executing level, receives, from the external device, second content using the communication unit, the second content being displayed at a lower executing level of the first executing level, and displays the received second content on the display unit.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a display device according to one embodiment;

FIG. 2 is a view illustrating a display device and an external device paired with the display device according to one embodiment;

FIG. 3 is a view illustrating a display device configured to detect an input state of a touch input according to one embodiment;

FIG. 4A is a view illustrating a display device detecting a touch input in a first input state according to one embodiment;

FIG. 4B is a view illustrating a display device having detected a touch input in a second input state according to one embodiment;

FIGS. 5A and 6A are views illustrating first content of a first executing level and second content of a second executing level according to one embodiment;

FIGS. 5B and 6B are views illustrating an external device displaying the first content and a display device displaying the second content according to one embodiment;

FIG. 7 is a view illustrating a display device displaying a moving image editing interface as the second content;

FIG. 8 is a view illustrating a public display which is a display device configured to display the second content according to one embodiment;

FIG. 9 is a view illustrating an external device and a display device which perform a content switching operation according to one embodiment;

FIGS. 10A to 10C are views illustrating a display device detecting a touch input for setting a region in which content is displayed according to one embodiment;

FIG. 11 is a view illustrating a display device determining the direction to display content according to a touch input by the right hand or the left hand according to one embodiment; and

FIGS. 12A to 12C are flowcharts illustrating a method for controlling the display device.

### DETAILED DESCRIPTION OF THE INVENTION

The terms used in this specification are selected, as much as possible, from general terms that are widely used in the art at present while taking into consideration of the functions of the elements, but these terms may be replaced by other terms according to intentions of those skilled in the art, customs, emergence of new technologies, or the like. In addition, in a specific case, terms that are arbitrarily selected by the applicant may be used. In this case, meanings of these terms may be disclosed in corresponding parts of this specification. Accordingly, it should be noted that the terms used herein should be construed based on practical meanings thereof and the whole content of this specification, rather than being simply construed based on names of the terms.

Reference will now be made in detail to the preferred embodiments of the present disclosure, examples of which are illustrated in the accompanying drawings. Wherever possible, the same reference numbers will be used throughout the drawings to refer to the same or like parts. However, the scope of the present disclosure is not limited to the illustrated embodiments.

The display device disclosed in this specification may include various types of devices such as a smartphone, a tablet computer, a desktop computer, a personal digital assistant (PDA) and a laptop computer which are capable of communication with other devices. In addition, the external device disclosed in this specification may represent a wearable device such as a smart watch, a head mounted display (HMD), a head-up display (HUD), a smart lens and a smart ring which are wearable on a user's body and are capable of communication with other devices. Particularly, in this specification, a description will be given of a smartphone provided as an example of the display device and a smart watch provided as an example of the external device.

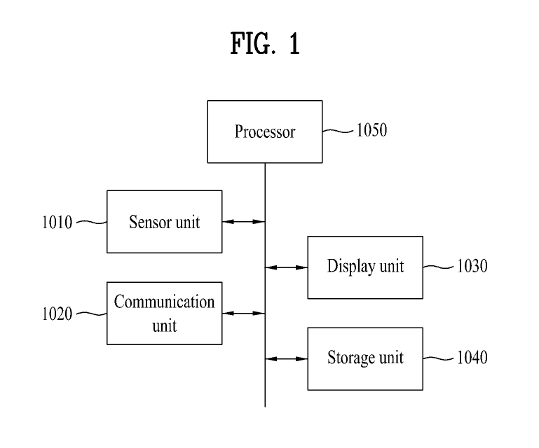

FIG. 1 is a block diagram illustrating a display device according to one embodiment. Referring to FIG. 1, the display device may include a sensor unit 1010, a communication unit 1020, a display unit 1030, a storage unit 1040 and a processor 1050.

The sensor unit 1010 may sense an input to the display device. More specifically, the sensor unit 1010 may sense an input to the display device using at least one sensor mounted to the display device, and transmit the result of sensing to the processor 1050. Herein, the at least one sensor may be a gravity sensor, a geomagnetic sensor, a motion sensor, a gyro sensor, an acceleration sensor, an infrared sensor, an inclination sensor, a brightness sensor, an altitude sensor, an olfactory sensor, a temperature sensor, a depth sensor, a pressure sensor, a bending sensor, an audio sensor, a video sensor, a global positioning system (GPS) sensor, a grip sensor, or a touch sensor. The sensor unit 1010 may be a general term covering such various sensing means. In addition, the sensor unit 1010 may sense various user inputs and user environments, and transmit the result of sensing to the processor 1050 to allow the processor 1050 to perform corresponding operations. The aforementioned sensors may be included in the display device as separate elements, or may be integrated into at least one element to be included in the device.

Particularly, the sensor unit 1010 may detect a touch input to the display device. More specifically, the sensor unit 1010 may detect a touch input to the display unit 1030 provided to the display device. Accordingly, the sensor unit 1010 may be integrated with the display unit 1030 or provided with a plurality of layers to be provided to the display device. The sensor unit 1010 may sense various touch inputs, whether contact inputs or non-contact inputs, such as a side touch input, a multi-touch input, a long-press touch input, a short-press touch input, a drag touch input, a hovering input, or a flicking touch input. The sensor unit 1010 may also sense touch inputs by various touch input tools such as a touch pen and a stylus pen. The sensor unit 1010 may transmit the result of sensing of various touch inputs to the processor 1050.

The communication unit 1020 may perform communication with an external device based on various protocols, thereby transmitting information to the external device or receiving information from the external device. In addition, the communication unit 1020 may access a wired or wireless network to transmit various digital data such as content to the external device or receive information from the external device. In addition, the communication unit 1020 may perform human body communication with the external device. Herein, the human body communication may represent a communication scheme using a user's body as a communication medium. Accordingly, in this case, the communication unit 1020 may include at least one human body communication device.

Meanwhile, the processor 1050 may perform communication with an external device which is within a predetermined distance from the display device, using the communication unit 1020. Further, the processor 1050 may perform the pairing operation using the external device and the communication unit 1020. Particularly, the processor 1050 may receive content of a lower executing level than the content being displayed on the external device from the external device, which will be decried in detail later.

The display unit 1030 may display an image. In other words, the display unit 1030 may display an image on a display screen. The display unit 1030 may display an image based on a control command from the processor 1050. Herein, the image may represent pictures, photos, texts, moving images, videos, content, and the like which are recognizable through the user's eyes. Particularly, in the present disclosure, the display unit 1030 may display content executed at a certain executing level, which will be described in detail below.

The storage unit 1040 may store various kinds of digital information. More specifically, the storage unit 1040 may store various kinds of digital information such as image information, audio information, video information and content information. The storage unit 1040 may represent various digital information storing spaces such as a flash memory, a random access memory (RAM) and a solid state drive (SSD).

The processor 1050 may process data in the display device to execute various kinds of content. In addition, the processor 1050 may control content executed on the display device, based on a content control command. In addition, the processor 1050 may control the respective units of the display device and may also control transmission/reception of data between the units.

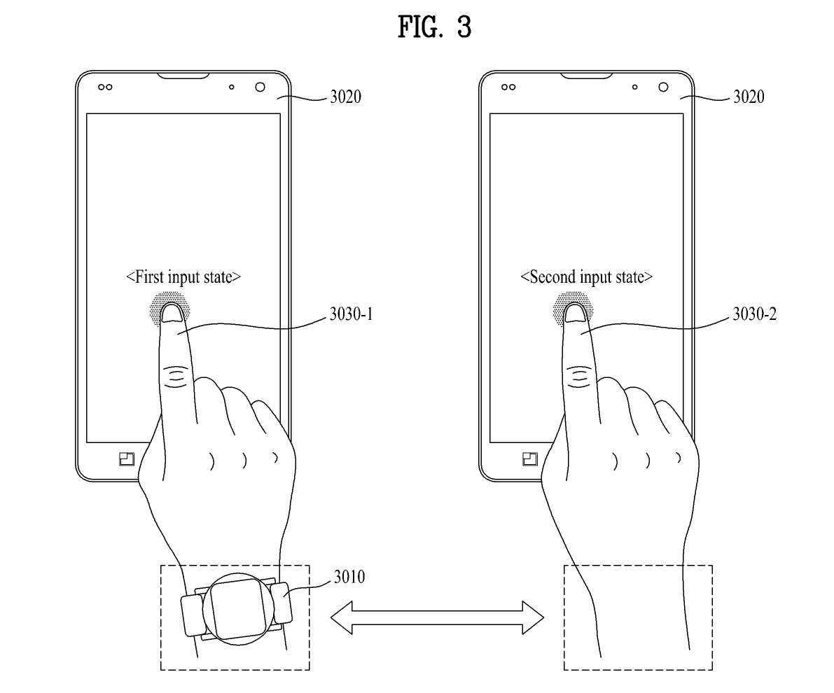

Particularly, the processor 1050 may detect an input to the display device using the sensor unit 1010. At this time, the processor 1050 may detect the state of the detected input. In the present disclosure, the input state may include a first input state in which the input is detected with the external device worn on the user's body and a second input state in which the input is detected with the external device unworn on the user's body. Such input states may be detected using the communication unit 1020, which will be described in detail later with reference to FIG. 3.

In addition, the processor 1050 may display, on the display unit 1030, content to be displayed at a plurality of executing levels. Particularly, the processor 1050 may receive, from the external device, content of a lower executing level for the content of a higher executing level being displayed by the external device, using the communication unit 1020. Then, it may display the received the content of the lower executing level on the display unit 1030. Thereby, rather than mirroring the content being displayed by the external device on the display device, the processor may provide contents of different executing levels through plural devices. Accordingly, the user may use the plural devices more efficiently. Further, the user may select a device suitable for displaying content of each executing level, which will be described in more detail later.

Hereinafter, the process of generating and receiving a signal according to a sensed user input as described above will be assumed to be involved in the case that a step or operation performed by the display device is started proceeded by sensing an input, even if the description thereof is not repeated. In addition, the processor 1050 may be described as controlling the display device or at least one unit included in the display device according to an input, and the processor 1050 may be equated with the display device.

In the block diagram of FIG. 1 illustrating one embodiment, the separated blocks logically distinguish hardware elements of the display device from each other. Accordingly, the elements of the aforementioned display device may be mounted in a single chip or a plurality of chips, depending on design of the display device.

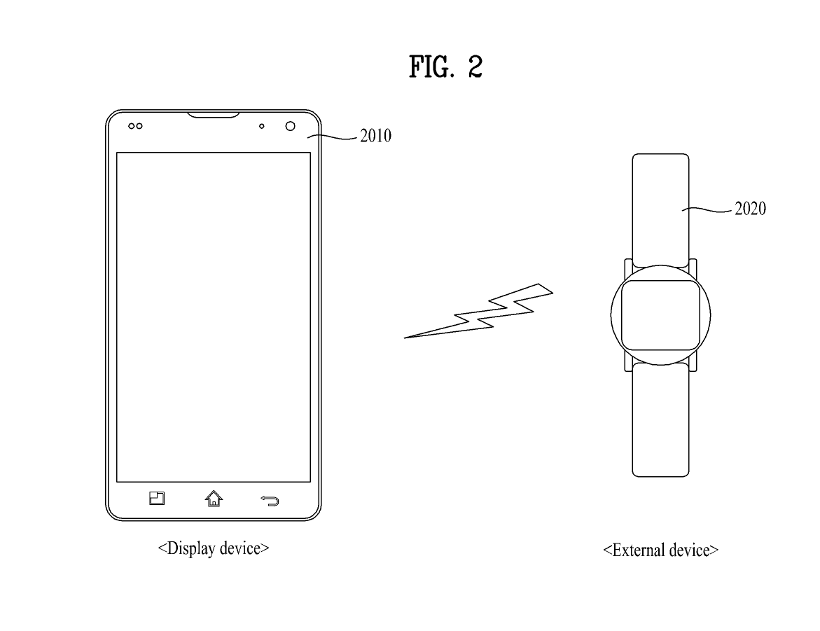

FIG. 2 is a view illustrating the display device and an external device paired with the display device according to one embodiment.

A display device 2010 may perform pairing with an external device 2020 using the communication unit. Herein, the display device 2010 may be a smartphone, and the external device 2020 may be a smart watch, as described above.

The pairing may represent connection for transmission and reception of information between the display device 2010 and the external device 2020. When the display device 2010 and the external device 2020 performs the pairing, unidirectional and/or bidirectional transmission and reception of information is possible. Particularly, the display device 2010 and the external device 2020 may perform the pairing, using various communication protocols such as such as WLAN (Wireless LAN), Wi-Fi, WiBro (Wireless Broadband), WiMAX (World Interoperability for Microwave Access), HSDPA (High Speed Downlink Packet Access), Bluetooth, NFC (Near Field Communication), and human body communication

The display device 2010 may perform pairing with a plurality of external devices 2020. In this case, the display device 2010 may perform communication access to selectively transmit/receive information with some of the external devices 2020.

The display device 2010 may perform pairing with a specific external device 2020 according to a pairing setting input through a pairing setting interface. Alternatively, in the case that the display device 2010 detects an external device 2020 which is within a predetermined distance and accessible for communication, the display device 2010 may perform pairing with this external device 2020.

FIG. 3 is a view illustrating a display device configured to detect an input state of a touch input according to one embodiment.

A display device 3020 may detect a touch input to a display device 3020. At this time, the display device 3020 may additionally detect the state of the touch input. The state of the touch input may include a first input state in which the external device 3010 is detected to be worn on the user's body and a second input state in which the external device 3010 is detected to be unworn on the user's body. The external device 3010 may include wearable devices which are wearable on the user's body.

For example, as shown in FIG. 3, in the case that a touch input 3030-1 by a hand of the user on which a smart watch is worn is detected, the display device 3020 may detect the touch input 3030-1 to be in the first input state. In addition, in the case that a touch input 3030-2 by the other hand of the user on which the smart watch is not worn is detected, the display device 3020 may detect the touch input 3030-2 to be in the second input state.

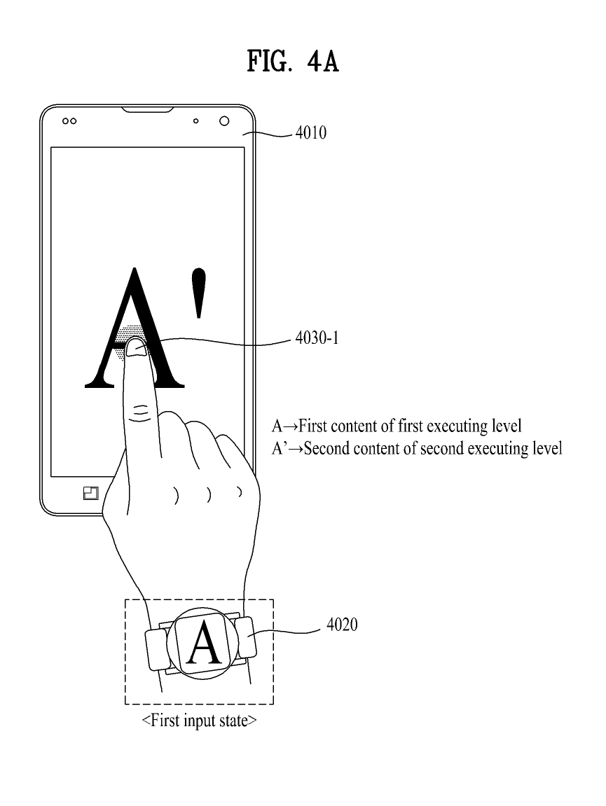

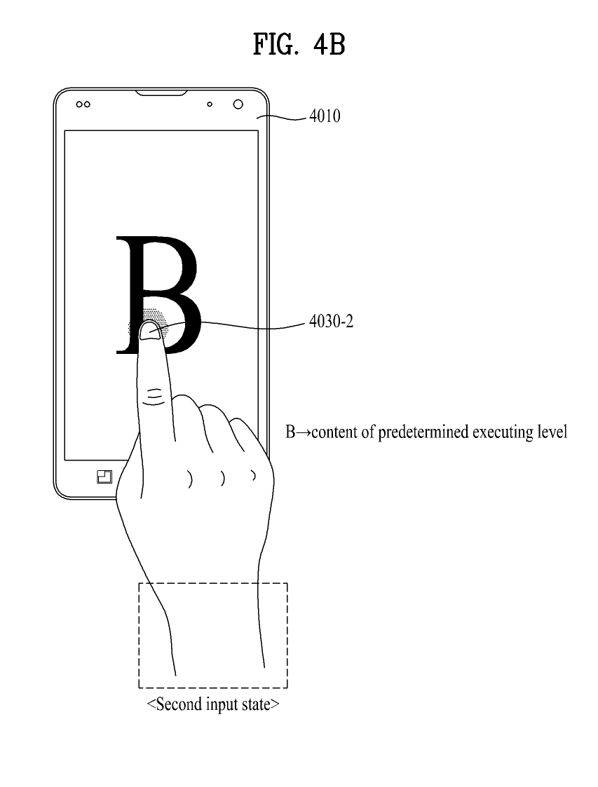

The display device 3020 may display content of a different executing level according to the detected state of the touch input, which will be describe in detail later with reference to FIGS. 4A and 4B.

The display device 3020 may detect the state of a touch input by performing communication with the external device 3010 using the communication unit.

According to one embodiment, the display device 3020 may receive information about a wearing state of the external device 3010 from the external device 3010, and detect the state of the touch input based on the received information. More specifically, the display device 3020 may make a request to the external device 3010 for the information about the wearing state of the external device 3010. At this time, the display device 3020 may use the communication unit. Upon receiving the information, the external device 3010 may transmit, to the display device 3020, the information related to the wearing state as response information. At this time, the external device 3010 may use a wearing sensor unit to create information related to the wearing state. Herein, the wearing sensor unit may include at least one sensor configured to sense whether the external device 3010 is worn on the user's body. Accordingly, the wearing sensor unit may include at least one of a touch sensor, a pressure sensor, a camera sensor, a temperature sensor, a biosignal sensor, a motion sensor, and an illumination sensor. The display device 3020 may receive, as the response information, the information created by the wearing sensor unit, and detect the state of the touch input based on the received response information.

According to another embodiment, the display device 3020 may detect the wearing state of the external device 3010 using human body communication. For example, the display device 3020 may allow a micro electric current to flow through the user's body according to contact between the user's body and the display unit. By detecting change of the micro current, the display device 3020 may detect whether the external device 3010 is in contact with the user's body. Alternatively, in the case that the external device 3010 detects a micro current flowing from the display device 3020 and transmits detection information about the micro current to the display device 3020, the display device 3020 may detect the wearing state of the external device 3010 upon receiving the information.

The display device 3020 may detect the wearing state of the external device 3010 through various embodiments, and is not limited to the described embodiments.

FIG. 4A is a view illustrating a display device detecting a touch input in a first input state according to one embodiment.

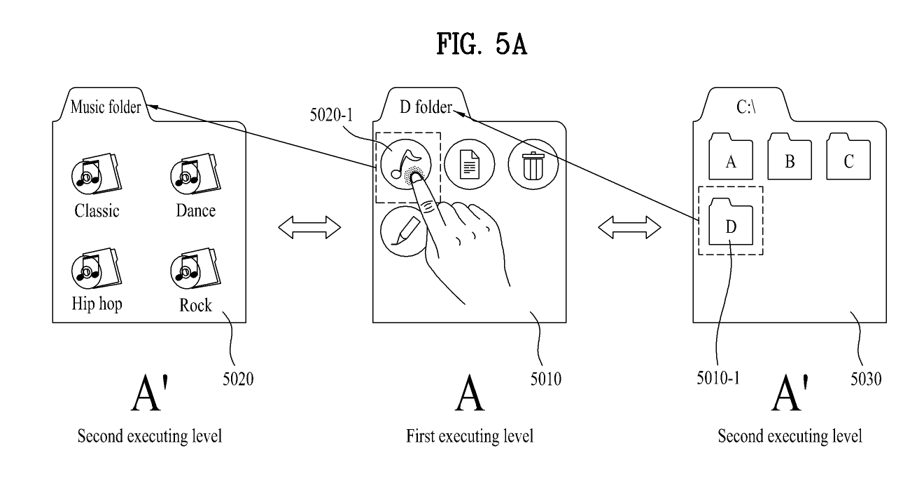

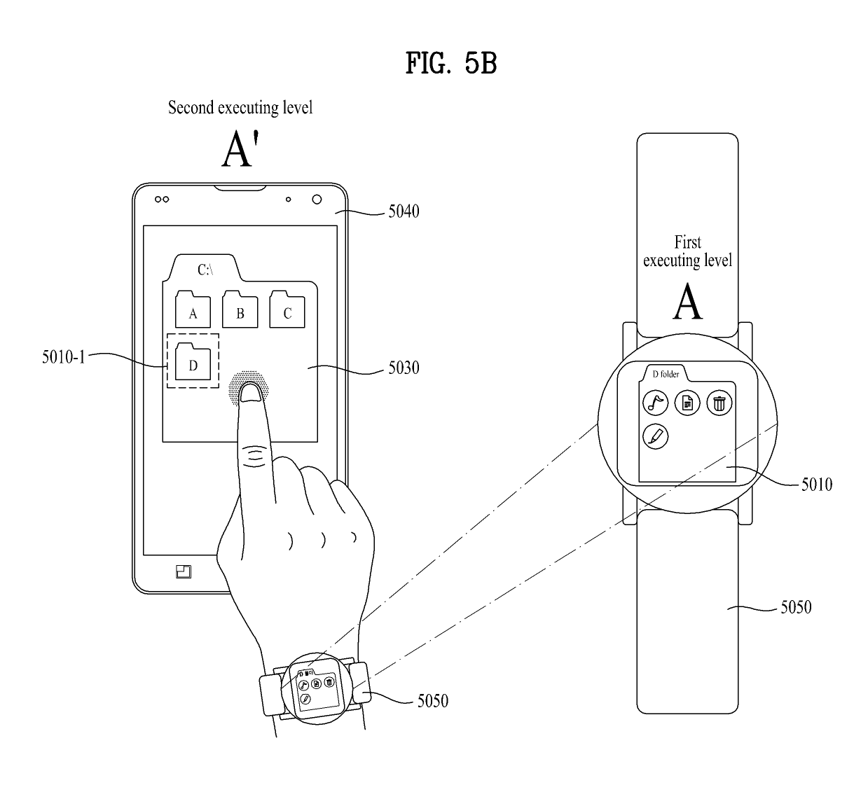

Upon detecting a touch input in the first input state, the display device 4010 may detect content being displayed on an external device 4020 worn on the user's body. Herein, the content may represent content having a plurality of executing levels. That is, upon detecting a touch input 4030-1 in the first input state, the display device 4010 may detect whether the external device 4020 is displaying content having a plurality of executing levels. The content having a plurality of executing levels may represent content capable of being executed or displayed through a plurality of steps. For example, specified information may be displayed according to a touch input for a photo. In this case, the photo may be considered as content having a plurality of executing levels. In addition, the specified information about the photo may be content of a lower executing level for the photo. Alternatively, an application contained in a folder may be executed according to a touch input for the folder. In this case, the folder may be considered as content having a plurality of executing levels. In addition, an execution window of the application contained in the folder may be viewed as content of a lower executing level for the folder. There may be various other embodiments of content, which will be described in detail below with reference to FIGS. 5A to 7.

Upon detecting that content having a plurality of executing levels is being displayed on the external device 4020, the display device 4010 may detect whether the content being displayed on the external device 4020 is first content displayed at a first executing level. In other words, upon detecting that the external device 4020 is displaying content having a plurality of executing levels, the display device 4010 may additionally detect whether the content is the first content displayed at the first executing level. Herein, the first executing level may represent a level including a second executing level, which includes at least one lower executing level. That is, the first executing level may represent a higher executing level for the second executing level, and the second executing level may represent a lower executing level for the first executing level. In addition, the content of the first executing level may be upper-level content for the content of the second executing level, and the content of the second executing level may represent the lower-level content for the content of the first executing level.

In the case that the first content of the first executing level is detected, the display device 4010 may receive, from the external device 4020, the second content displayed at the second executing level which is a lower executing level than the first executing level. That is, upon detecting the first content that the external device 4020 is displaying, the display device 4010 may receive the second content from the external device 4020. At this time, the display device 4010 may receive the second content from the external device 4020 using the communication unit.

Having received the second content, the display device 4010 may display the received second content. More specifically, in the case that the display device 4010 receives the second content from the external device 4020, it may display the received second content on the display unit.

That is, the display device 4010 may display, at a different executing level, the content provided through the external device 4020, rather than simply mirroring the content of the external device 4020. This may allow the user to efficiently use plural devices. In addition, this may allow the user to select content of an executing level suitable for each device, taking the characteristics of the respective devices into account.

FIG. 4B is a view illustrating a display device having detected a touch input in a second input state according to one embodiment.

As described above with reference to FIG. 3, the display device 4010 may detect a touch input 4030-2 which is in the second input state. Upon detecting the touch input 4030-2 of the second input state, the display device 4010 may display content based on the information stored in the storage unit. That is, the display device 4010, which displays content based on the information stored in the external device 4020 upon detecting the touch input 4030-1 of the first input state, may display content based on the information stored in the storage unit upon detecting the touch input 4030-2 of the second input state.

At this time, the display device 4010 display content at a predetermined executing level. For example, in the case that the touch input 4030-2 of the second input state is detected, the display device 4010 may display first content of a first executing level. The predetermined executing level may be set to various levels according to the type of executed content, manufacturing processes arranged by the manufacturer, design formula of the device, setting by the user, and the like, and is not limited to the described embodiment.

Meanwhile, the content to be displayed according to the touch input 4030-2 of the second input state may be determined by the touch input 4030-2 of the second input state. In other words, the display device 4010 may determine content to be displayed based on the touch input 4030-2 of the second input state. According to one embodiment, the display device 4010 may determine content to be displayed based on the “position” of the touch input 4030-2 of the second input state. That is, the display device 4010 may detect the position of the touch input 4030-2 of the second input state, and display content corresponding to the detected position. For example, in the case that the display device 4010 detects the touch input 4030-2 of the second input state at a first point, it may display the first content corresponding to the first point. Herein, the first point may represent a position at which an executing icon of the first content is displayed. The display device 4010 may determine content to be displayed based on the touch input 4030-2 of the second input state detected through various other embodiments, and is not limited to the aforementioned embodiments. Once content to be displayed is determined, the determined content may be displayed at a predetermined executing level, as described above.

FIG. 5A is a view illustrating first content of a first executing level and second content of a second executing level according to one embodiment. FIG. 5B is a view illustrating an external device displaying the first content and a display device displaying the second content according to one embodiment.

In one embodiment of content having a plurality of executing levels, the display device and/or the external device may display a folder. Particularly, the external device may display a folder 5010 as the first content of the first executing level. The display device and/or the external device may provide various embodiments as the second content of the second executing level corresponding to the first content 5010.

In one embodiment, the second content 5020 may be content included in the first content 5010. Considering the nature of the first content 5010, the first content 5010 may include at least one sub-content 5020-1. Herein, the sub-content 5020-1 may represent a “content executing icon” 5020-1 corresponding to specific content 5020. The content 5020 corresponding to the content executing icon” 5020-1 included in the first content 5010 may be the second content 5020. For example, in the case that the first content 5010 is a D folder, a music folder executing icon 5020-1 is included in the D folder, the second content 5020 may be a music folder 5020 corresponding to the music folder executing icon 5020-1.

In the case that a plurality of sub-contents 5020-1 is included in the first content 5010, the external device may detect a selection input for selection of at least one of the sub-contents 5020-1. Upon detecting the selection input, the external device may transmit, to the display device, the second content(s) 5020 corresponding to sub-content(s) 5020-1 selected by the selection input. Upon receiving the at least one second content 5020, the display device may display the received second content(s) 5020 on the display unit. At this time, the display device may use the communication unit.

For example, in the case that the external device is displaying the D folder 5010, the D folder 5010 may include, as sub-contents, a music folder executing icon 5020-1, a document folder executing icon, a recycle bin folder executing icon and a notepad folder executing icon (see FIG. 5A). At this time, the external device may detect the user's selection input touching the music folder executing icon 5020-1. In this case, the external device may transmit the music folder 5020 corresponding to the selected music folder executing icon 5020-1 to the display device according to a content requesting signal from the display device. In this case, the display device may detect the touch input which is in the first state, and transmit the content request signal to the external device. As a result, the display device may display the received the music folder 5020 as the second content.

In another embodiment, the second content may be a content group 5030 including the first content 5010. More specifically, the second content 5030 may represent a content group 5030 including sub-content 5010-1 corresponding to the first content 5010. Accordingly, in the case that the first content 5010 is a folder, the second content 5030 may be an upper-level folder 5030 including, as sub-content, a folder executing icon 5010-1 corresponding to the first content (folder) 5010.

For example, in the case that the first content is the D folder 5010, the second content 5030 may be a C drive folder 5030 including a D folder executing icon 5010-1 as the sub-content. Herein, the D folder executing icon 5010-1 may represent a content executing icon corresponding to the D folder 5010. Accordingly, in the case that the touch input in the first input state is detected and the D folder 5010 is being displayed on the external device, the display device may receive the C drive folder 5030 from the external device. In addition, the display device may display the received C drive folder 5030 on the display unit.

As a result, as shown in FIG. 5B, the external device 5050 may display the D folder 5010 as the first content of the first executing level, and the display device 5040 may display the C drive folder 5030 including the D folder executing icon 5010-1 as the second content of the second executing level.

The first content of the first executing level or the second content of the second executing level may be implemented in various other embodiments for a folder and are not limited to the embodiment described above. The embodiments may have various variations within a scope acceptable by those skilled in the art.

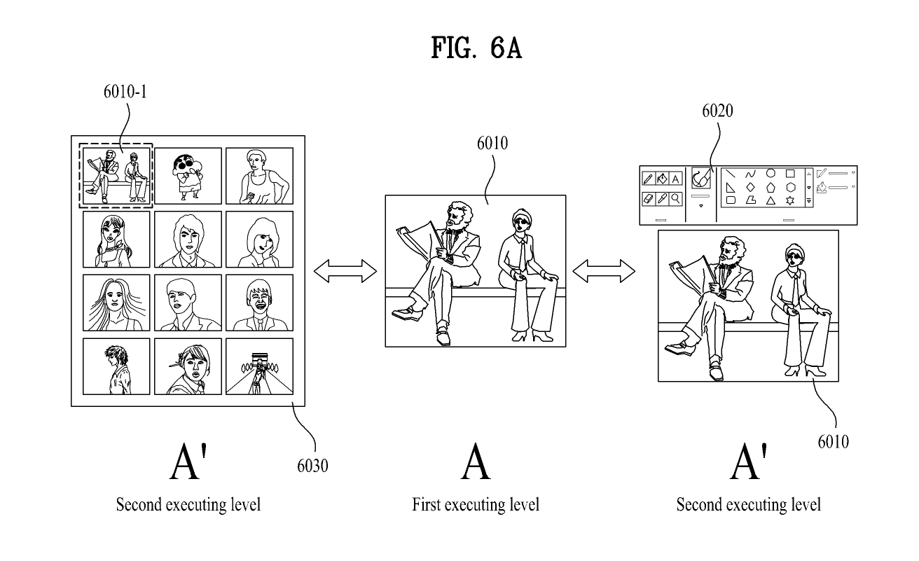

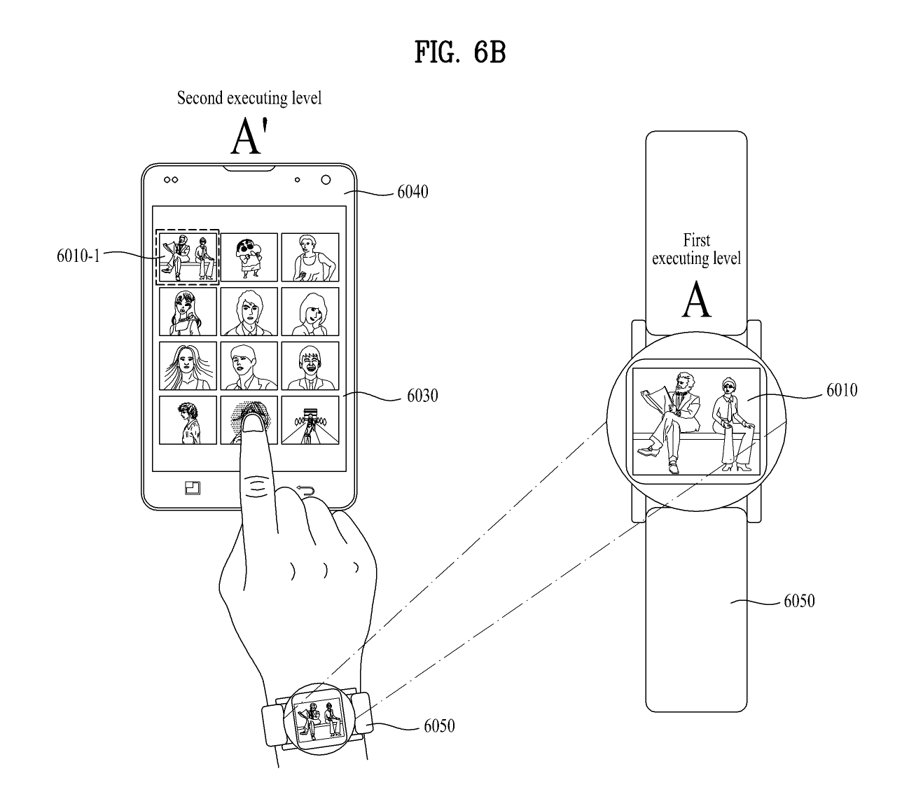

FIG. 6A is a view illustrating first content of the first executing level and second content of the second executing level according to one embodiment. FIG. 6B is a view illustrating an external device displaying the first content and a display device displaying the second content according to one embodiment.

The display device and/or the external device may display an image 6010 as the first content of the first executing level. Herein, the image 6010 may represent pictures, photos, texts, moving images, videos, content, and the like which are recognizable through the user's eyes. The display device and/or the external device may provide various embodiments as the second content of the second executing level corresponding to the first content 6010.

In one embodiment, the second content may be a “content editing interface” 6020 for the first content 6010. That is, the display device and/or the external device may provide a content editing interface 6020 capable of editing the first content 6010 as the second content for the first content 6010. For example, in the case that the first content 6010 is a photo, the second content may be a photo editing interface 6020 for editing the photo (see FIG. 6A).

Accordingly, in the case that the display device detects a touch input of the first input state and the external device is displaying the image 6010, the display device may receive an editing interface 6020 for the image 6010 from the external device. In addition the display device may display the received image editing interface 6020 on the display unit. In the case that the image editing interface 6020 is separately stored in the storage unit, the display device may receive only the image 6010 from the external device, autonomously display the image editing interface 6020 for the received image 6010. This may allow the user to edit the image 6010 on the large screen of the display device rather than on the small screen of the external device, thereby allowing a delicate image editing operation.

In another embodiment, the second content may be a content group 6030 including the first content 6010. More specifically, the second content may represent a content group 6030 including sub-content 6010-1 corresponding to the first content 6010. Accordingly, in the case that the first content is an image 6010, the second content 6030 may be an image group 6030 including an image thumbnail 6010-1 corresponding to the first content 6010 as the sub-content.

For example, in the case that the first content is a photo 6010, the second content may be a photo group 6030 including a photo thumbnail 6010-1 corresponding to the photo (see FIG. 6A). Accordingly, in the case that a touch input of the first input state is detected and the image 6010 is being displayed on the external device, the display device may receive, from the external device, the image group 6030 including the thumbnail 6010-1 of the image 6010. In addition, the display device may display the received image group 6030 on the display unit.

As a result, the external device 6050 may display the photo 6010 as the first content of the first executing level, and the display device 6040 may display a photo group 6030 including the thumbnail 6010-1 of the photo as the second content of the second executing level, as shown in FIG. 6B.

The first content of the first executing level or the second content of the second executing level may be implemented in various other embodiments for an image and are not limited to the embodiment described above. The embodiments may have various variations within a scope acceptable by those skilled in the art.

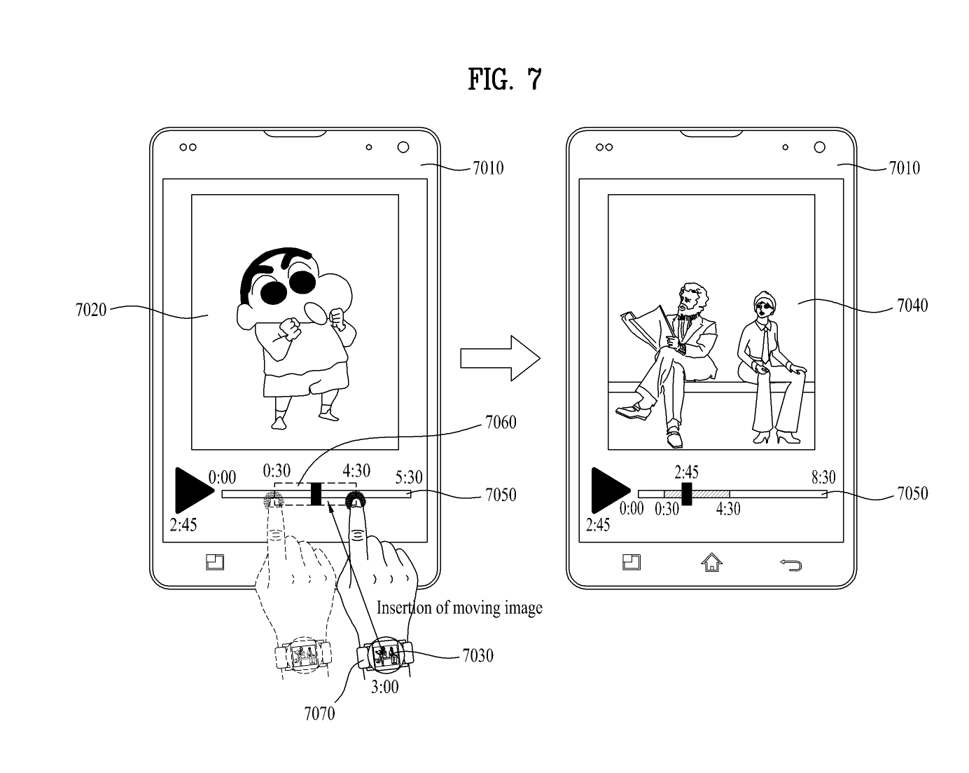

FIG. 7 is a view illustrating a display device displaying a moving image editing interface as the second content.

In view of the description given above with reference to FIG. 6A and 6B, the external device 7070 may display a moving image 7030 as the first content of the first executing level, and the display device 7010 may provide a moving image editing interface for the moving image 7030 as the content editing interface for the first content. The user may perform various moving image editing operations using the moving image editing interface.

Particularly, the user may perform a moving image inserting operation of inserting a first moving image 7030 in a second moving image 7020, using the moving image editing interface. More specifically, the user may readily perform an editing operation of inserting the first moving image 7030 being displayed on the external device 7070 in the second moving image 7020 being displayed on the display device 7010.

First, in the case that the first moving image 7030 is being displayed on the external device 7070 and the touch input in the first state is detected, the display device 7010 may display a moving image editing interface for the first moving image 7030. At this time, the user may provide a selection input to the display device 7010 to select the second moving image 7020 to insert the first moving image 7030. Herein, the second moving image 7020, which is stored in the display device 7010 or the external device 7070, may represent a moving image received from the external device 7070. Once the second moving image 7020 is selected according to the selection input, the display device 7010 may display the second moving image 7020 along with a timeline interface 7050. Herein, the timeline interface 7050 may represent a user interface indicating the reproduction sequence of the second moving image 7020 in time unit.

Next, the user may provide a setting input of setting an editing section 7060 in the reproduction sequence of the second moving image 7020. For example, as shown in FIG. 7, the user may set the editing section 7060 of the timeline interface 7050 through a drag input to the timeline interface 7050. Once the editing section 7060 is set, the external device 7070 may transmit the first moving image 7030 currently being displayed to the display device 7010. Upon receiving the first moving image 7030 from the external device 7070, the display device 7010 may insert the first moving image 7030 in the predetermined editing section 7060 of the second moving image 7020. As a result, the display device may produce a third moving image 7040 having the first moving image inserted in the middle of the second moving image.

Through the simple touch input as above, the user may readily insert the first content 7030 provided by the external device 7070 in the second content 7020 provided by the display device 7010. Accordingly, easy editing may be possible.

In this embodiment, the first moving image 7030 being displayed by the external device 7070 is illustrated as being inserted in the second moving image 7020 displayed by the display device 7010. The user may insert various kinds of the first content in the second content in a similar manner. For example, in the case that the user wearing the external device 7070 which is displaying a first folder touches a second folder being displayed on the display device 7010, the user may transfer the first folder to the second folder. Alternatively, in the case that the user wearing the external device 7070 which is displaying a document file touches a mail message composition interface being displayed by the display device 7010, a corresponding document file may be attached to the mail message currently being composed. Embodiments of the present disclosure are not limited thereto. There may be other embodiments.

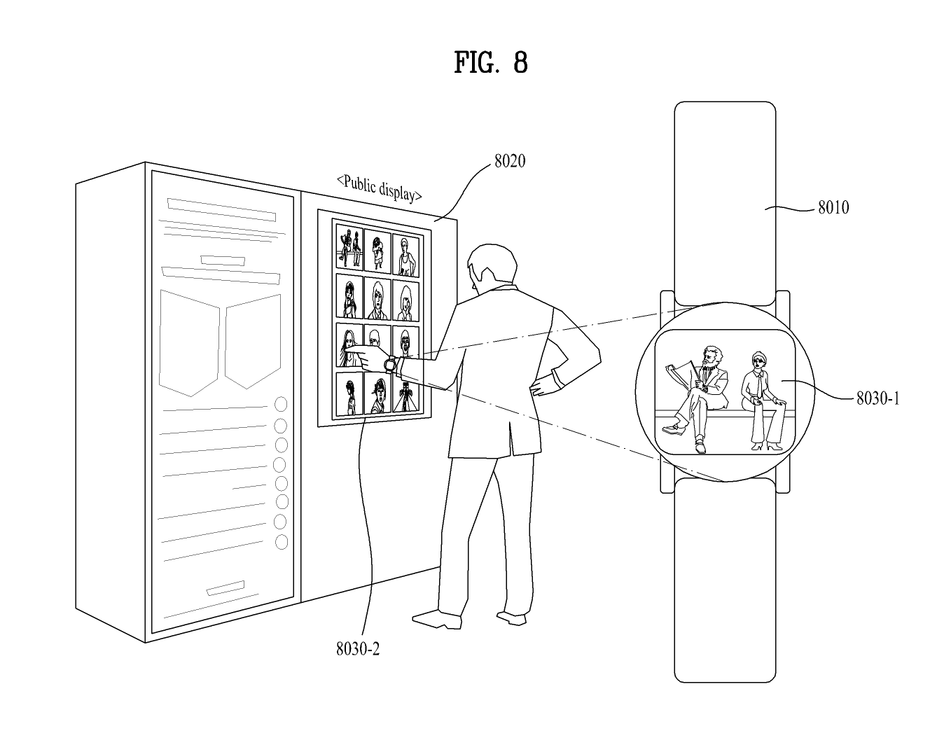

FIG. 8 is a view illustrating a public display which is a display device configured to display the second content according to one embodiment.

Display devices may be divided into a private display and a public display based on use and purpose. Herein, the private display may represent a closed-type display device that is used by a person for a personal use. In addition, the public display 8020 may represent an open-type display device installed in a public space (e.g., a street, a subway station, a bus station, a public restroom, etc.) to be publicly used.

In the case that the user possesses no private display or desires to use a larger screen than the screen of a private display, the user may usefully use the public display 8020 as a display device 8020 configured to display the second content.

The user may touch the public display 8020, wearing the external device 8010 that is displaying the first content 8030-1. In this case, the public display 8020 may detect the touch input which in the first input state. As a result, the public display 8020 may receive second content 8030-2 from the external device 8010 and display the received second content 8030-2. The process in which the public display 8020 detect the state of the touch input and displays the second content 8030-2 may be the same as or similar to the process as described above.

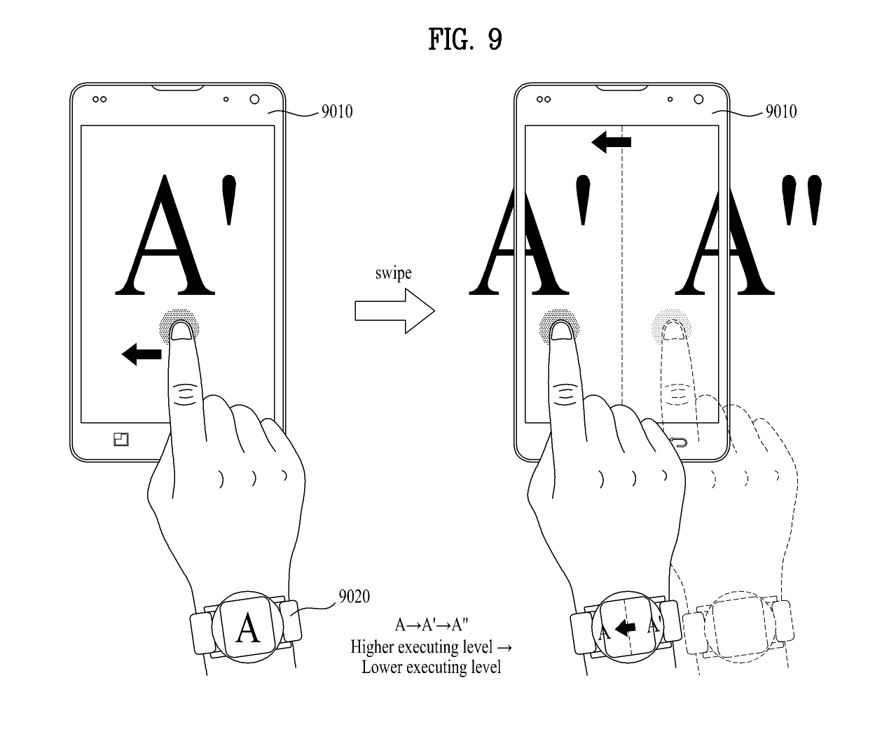

FIG. 9 is a view illustrating an external device and a display device which perform a content switching operation according to one embodiment.

The display device 9010 and/or the external device 9020 may switch content being displayed to other content in response to switching of content in a counterpart device paired therewith. In other words, the display device 9010 may switch the content currently being displayed to other content in response to the content switching operation by the external device 9020. Alternatively, the external device 9020 may switch the content currently being displayed to other content in response to the content switching operation by the display device 9010.

For example, in the case that the external device 9020 is displaying the first content and the display device 9010 is displaying the second content for the first content, the display device 9010 may detect a content switching input for the second content being displayed thereon. The content switching input may represent various touch inputs to the content being displayed, such as a swipe touch input, a drag touch input, a short-press touch input, and a long-press touch input. In this embodiment, the display device 9010 detects a swipe touch input to the content being displayed as the content switching input. Upon detecting the swipe input, the display device 9010 may switch the second content being displayed to third content which is content of a lower executing level than the second content. At this time, the display device 9010 may transmit the information about the content switching operation to the external device 9020, and then receive third content from the external device 9020. As a result, the display device 9010 may switch the second content to the third content, and at the same time the external device 9020 may switch the first content being displayed thereon to the second content.

In this embodiment, the display device 9010 detects the content switching input. However, even in the case that the external device 9020 detects the content switching input the display device 9010 may perform the content switching operation.

Thereby, the user may control switch of content in the display device 9010 and the external device 9020 with a content switching input to one device.

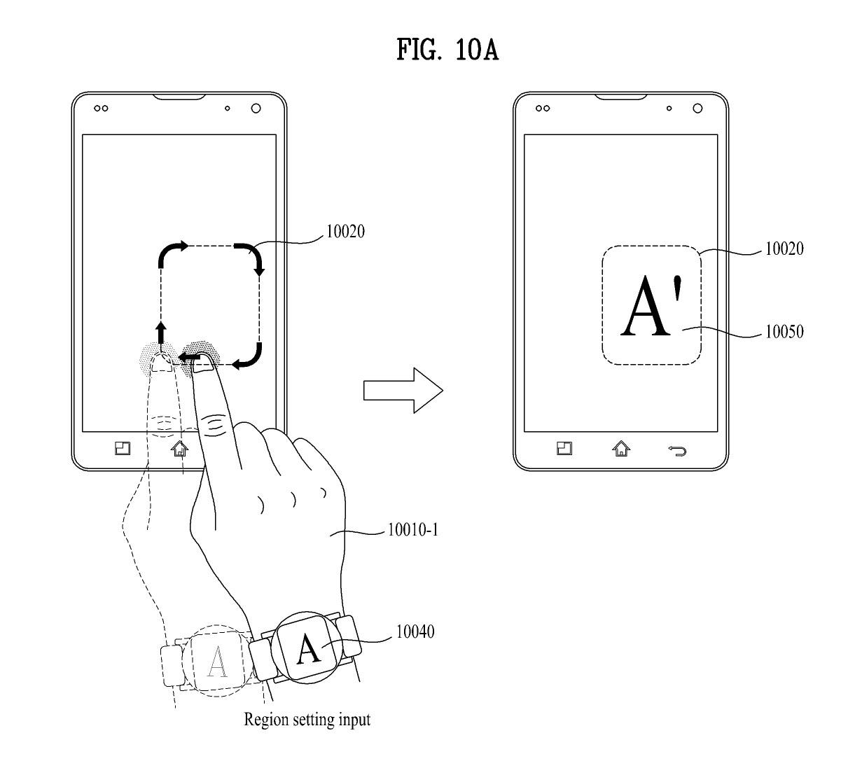

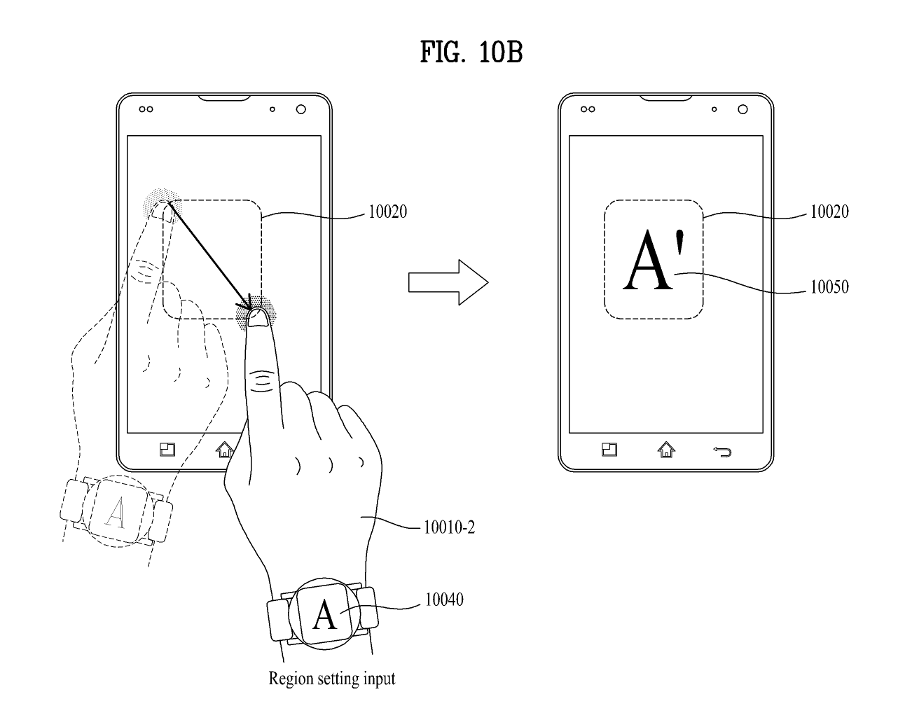

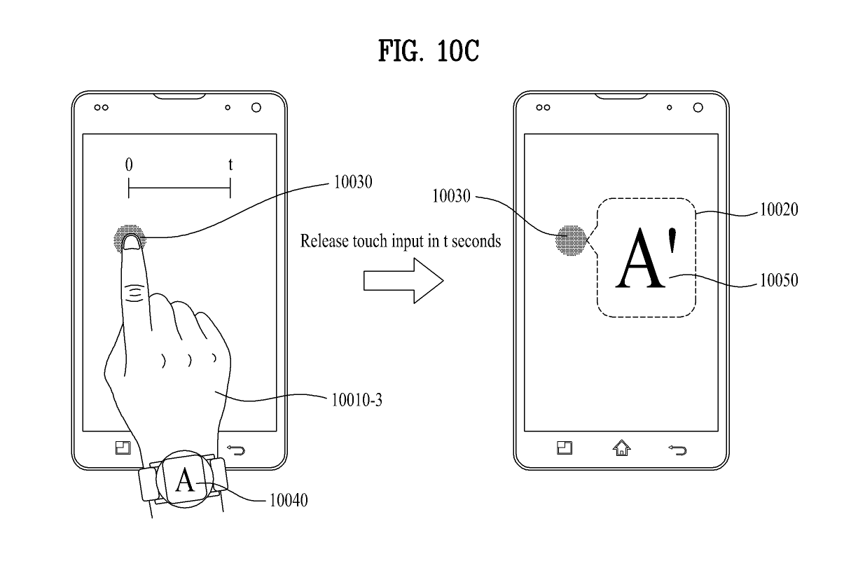

FIGS. 10A to 10C are views illustrating a display device detecting a touch input for setting a region in which content is displayed according to one embodiment.

The user may preset a region in which content 10050 is to be displayed. Particularly, the user may preset a region of the display device in which content 10050 is to be displayed. The region may be set in various embodiments.

According to one embodiment, a region 10020 in which the content 10050 is displayed may be set by a continuous touch input 10010-1, 10010-2 identifying the region. Herein, the continuous touch input 10010-1, 10010-2 may represent a touch input moving by a distance equal to or greater than a predetermined distance from the first touch point. The touch input 10010-1, 10010-2 may be divided into an input 10010-1 directly identifying the display region and an input 10010-2 indirectly identifying the display region.

For example, as shown in FIG. 10A, the user may directly identify the region 10020 for displaying the content 10050 in a specific geometric shape (e.g., a rectangular shape) through the touch input 10010-1 to the display unit. Herein, the identified region 10020 may be a closed region having a certain length and a certain width. Accordingly, the touch input 10010-1 identifying the region 10020 may a touch input in which the first touch point coincides with the last touch point.

Alternatively, as shown in FIG. 10B, the user may indirectly identify the region 10020 to display the content 10050. For example, the user may identify the region by identifying a straight line 10010-2 in a diagonal direction. The display device may set, as a region to display the content 10050, a rectangular region 10020 taking the straight light as a diagonal line thereof. Alternatively, the user may identify a straight line 10010-2 in a horizontal direction or vertical direction, and the display device may set, as the region 10020 to display the content, a rectangular region taking this straight line as the length or width thereof. At this time, the display device may set the region 10020 for display of the content 10050 in various shapes such as circle, triangle and diamond, based on the extension direction, angle and length of the detected straight line.

According to another embodiment, the region 10020 to display the content 10050 may be set by a long-press touch input 10010-3 designating a position 10030 of the region 10020. Herein, the long-press touch input 10010-3 may represent an input through which touch of the same position 10030 is maintained for more than a predetermined time t. In the case that such long-press touch input 10010-3 is detected, the display device may set the region 10020 having a predetermined size and shape based on the position 10030 at which the long-press touch input 10010-3 is detected.

For example, as shown in FIG. 10C, the user may apply a touch 10010-3 to the display unit and maintain the touch 10010-3 for t seconds. Upon detecting the touch input 10010-3 maintained for t seconds, the display device may set a predetermined region 10020 based on the position 10030 at which the touch input 10010-3 is detected. Herein, the predetermined region 10020, which represents a region whose size and/or shape are predetermined, may be set in various forms according to manufacturing processes arranged by the manufacturer, the purpose of the device, design formula, and setting by the user.

In the case that the region 10020 to display the content 10050 is set according the embodiments as described above, the display device may detect a touch input in the first state to the region 10020. In addition, in the case that first content 10040 of the external device is detected, the display device may receive second content 10050 from the external device and display the received second content 10050 in the content display region 10020 set in the embodiments described above. A relevant detailed description has been given above with regard to FIG. 4A.

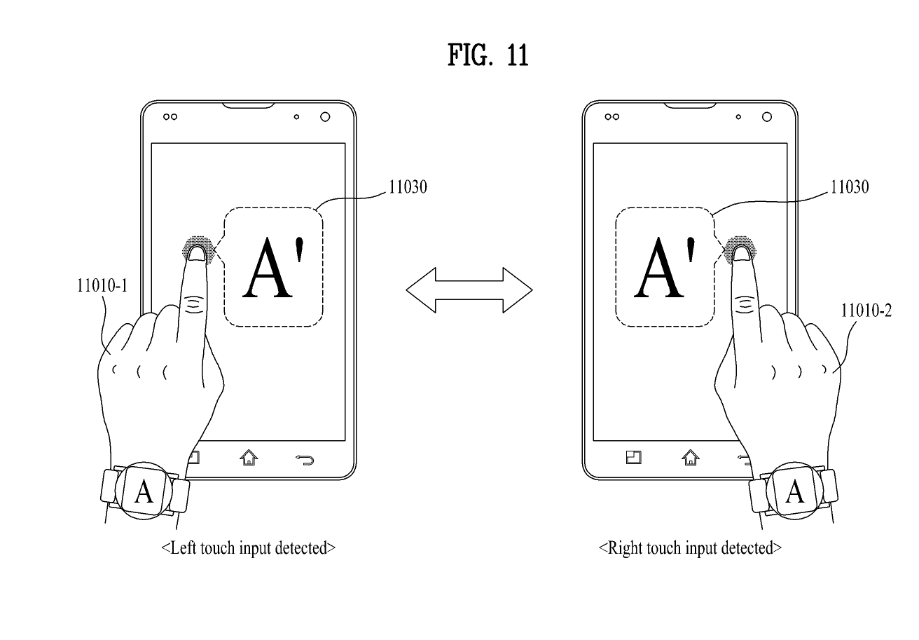

FIG. 11 is a view illustrating a display device determining the direction to display content according to a touch input by the right hand or the left hand according to one embodiment.

In displaying the content 11030, the display device may additionally detect whether the touch input for display of the content 11030 is a touch input 11010-1 by the right hand or a touch input 11010-2 by the left hand. This may be detected using various means such as the direction and angle of the touch input and a fingerprint of the touch input.

In the case that the touch input 11010-1 by the left hand is detected, the display device may display the content 11030 on the right side of the position of the detected touch input 11010-1. For example, in the case that a touch input of the first input state 11010-1 by the left hand is detected, the display device may display the content on the right side of the position of the detected touch input 11010-1.

In the case that the touch input 11010-2 by the right hand is detected, the display device may display the content 11030 on the left side of the position of the touch input 11010-2. For example, in the case that a touch input in the first input state 11010-2 by the left hand is detected, the display device may display the content 11030 on the left side of the detected touch input 11010-2.

In view of the physical structure of the hands, displaying the content 11030 on the right side of the touch input 11010-1 by the left hand and on the left side of the touch input 11010-2 by the right hand may secure a sufficient viewing field of the content for the user. Accordingly, in the present disclosure, the display device may efficiently display the content 11030 for the user by additionally detecting whether the detected touch input is the touch input 11010-2 by the right hand or the touch input 11010-1 by the left hand and determining the direction in which the content 11030 is displayed.

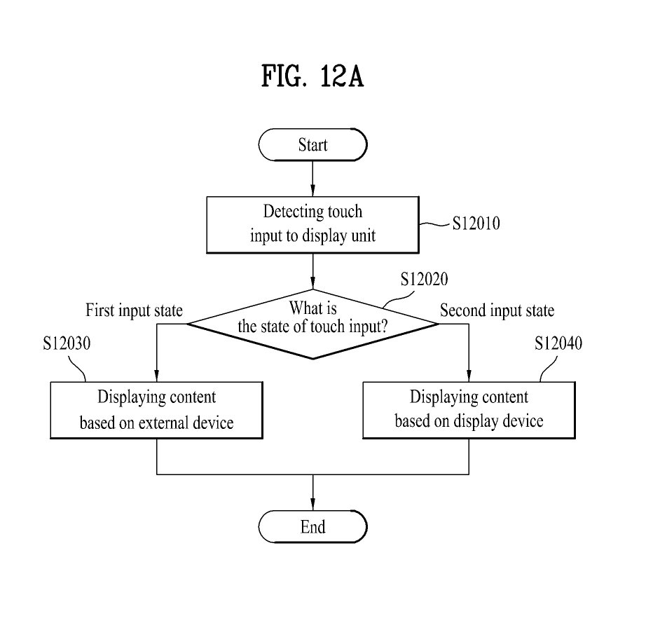

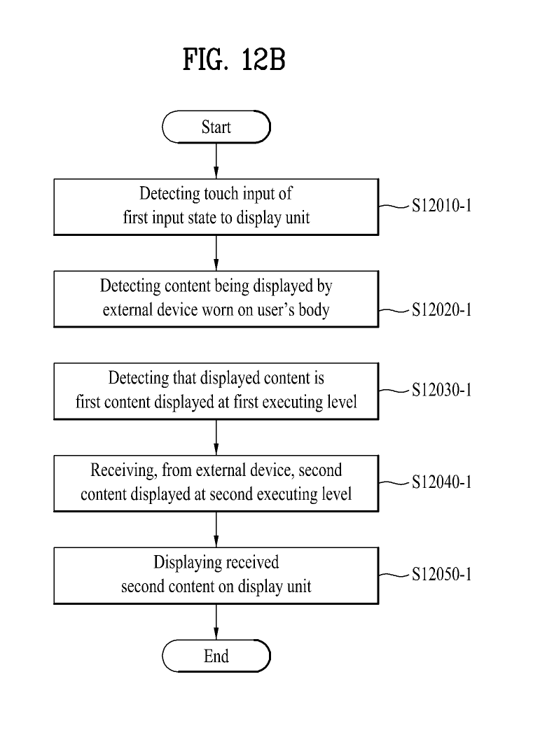

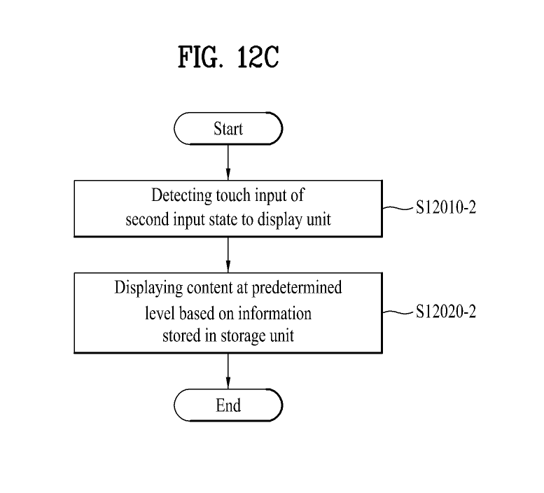

FIGS. 12A to 12C are flowcharts illustrating a method for controlling the display device. More specifically, FIG. 12A is a flowchart illustrating a method for controlling a display device having detected a touch input of the first input state. In this flowchart, details similar to or identical to those described above with reference to FIGS. 1 to 11 will not be described.

First, the display device may detect a touch input to the display unit (S12010). Herein, the touch input may represent a touch input sensible by a sensor unit provided to the display device. For example, the touch input may represent various touch inputs, whether contact inputs or non-contact inputs, such as a side touch input, a multi-touch input, a long-press touch input, a short-press touch input, a drag touch input, a hovering input, or a flicking touch input.

Next, the display device may detect the state of the touch input (S12020). Herein, the state of the touch input may include a first input state in which the touch input is detected with an external device worn on the user's body and a second input state in which the touch input is detected with the external device unworn on the user's body. The display device may detect whether the external device is worn or unworn on the user's body using a communication unit, which has been described in detail above with reference to FIG. 1. In addition, the external device represent may represent wearable devices which are wearable on the user's body.

In the case that the display device detects the state of the touch input to be the first input state, the display device may display content based on the external device (S12030). Herein, displaying the content based on the external device indicates receiving the content from the external device and displaying the received content. A detailed description related to this step will be given below with reference to the flowchart of FIG. 12B.

In the case that the display device detects the state of the touch input to be the second input state, the display device may display content based on the display device (S12040). Herein, displaying the content based on the display device indicates displaying the content stored in a storage unit provided to the display device. A detailed description related to this step will be given later with reference to the flowchart of FIG. 12C.

FIG. 12B is a flowchart illustrating a method for controlling a display device having detected a touch input in the first input state.

First, the display device may detect a touch input in the first input state to the display unit (S12010-1). Herein, the touch input in the first input state may represent a touch input detected with the external device worn on the user's body, as described above.

Next, the display device may detect content that the external device worn on the user's body is displaying (S12020-1). Herein, the content may represent content displayed at a plurality of executing levels. That is, the display device may detect the content displayed at a plurality of executing levels on the external device. There may be various examples of the content including an image, a folder, and an application. A relevant description has been given above with reference to FIGS. 5A to 7.

Next, the display device may detect that the displayed content is first content displayed at a first executing level (S12030-1). Herein, the first executing level may represent a level including a second executing level, which includes at least one lower executing level. The various examples of the content may be displayed at the first executing level. Various examples of the first content displayed at the first executing level have been described above with reference FIGS. 5A to 7.

Next, the display device may receive, from the external device, second content displayed at a second executing level (S12040-1). Herein, the second content may represent the content displayed at the first executing level. In this case, the display device may receive the second content from the external device using the communication unit. For example, the display device may transmit content request information to the external device, and the external device may transmit, upon receiving the content request information, the second content to the display device.

Next, the display device may display the received second content on the display unit (S12050-1). More specifically, the display device may display, on the display unit, the second content received from the external device using the communication unit. In this case, the display device may display the second content in a predetermined region. Particularly, the region in which the second content is displayed may be set by the user, which has been described in detail above with reference to FIGS. 10A to 10C.

FIG. 12C is a flowchart illustrating a method for controlling the display device having detected a touch input which is in the second input state.

First, the display device may detect a touch input in the second input state to the display unit (S12010-2). Herein, the touch input in the second input state may represent a touch input detected with the external device unworn on the user's body, as described above.

Next, the display device may display content at a predetermined executing level based on information stored in the storage unit (S12020-2). More specifically, the display device may display content according to the detected touch input, based on the information stored in the storage unit. In addition, in displaying the content, the display device may display the content at a predetermined executing level. For example, in the case that the display device displays an image as the content, the display device may display an image of the first executing level. The executing level at which the content is displayed may be set to various levels according to the manufacture, design formula and purpose of the device, setting by the user, and the like.

Although descriptions have been given for the respective drawings for ease of illustration, embodiments illustrated in the drawings may also be combined to implement a new embodiment. The scope of the present disclosure also covers designing a recording medium readable by a computer having a program recorded to execute the described embodiments, as desired by those skilled in the art.

In addition, a display device and a method for controlling the same according to the present disclosure are not limited to the described embodiments. Parts or all of the above embodiments can be selectively combined to produce various variations.

As is apparent from the above description, the present disclosure has effects as follows.

According to one embodiment, the display device displays content of a lower executing level for the content being displayed by the external device, Accordingly, the same content may be efficiently used through plural devices.

According to another embodiment, the display device determines the direction to display content based on whether the touch input is a touch input by the right hand or by the left hand. Accordingly, a sufficient view of the content may be secured for the user.

According to another embodiment, the display device displays a content group including content being displayed by the external device. It may help the user readily recognize the upper-level content including the content being displayed by the external device and/or other neighboring content.

According to another embodiment, the display device displays a content editing interface for the content being displayed by the external device. Accordingly, this may allow the user to edit content through a relatively large screen.

Details of the effects have been disclosed in the descriptions given above.

It will be apparent to those skilled in the art that various modifications and variations can be made in the present disclosure without departing from the spirit or scope of the present disclosure. Thus, the present invention is intended to cover the modifications and variations of this disclosure provided they come within the scope of the appended claims and their equivalents. The variations should not be separately understood from the spirit or prospect of the present disclosure.

In addition, the display device and the method for controlling the same of the present disclosure may be implemented, as code readable by a processor provided to a network device, in a recording medium readable by the processor. The recording medium readable by the processor includes all kinds of recording devices configured to store data readable by the processor. Examples of the recording medium readable by the processor include ROMs, RAMs, magnetic tapes, floppy disks, and optical data storage devices. Examples also include implementation in the form of a carrier wave such as transmission over the Internet. In addition, the recording medium readable by the processor may be distributed to computer systems connected over a network, and thus code readable by the processor may be stored and executed in a distributed manner.

In addition, in the present disclosure, the direction may not only represent accurate directions, but also include a substantial direction within a certain range. That is, the direction in the present disclosure may represent a substantial direction within a certain error range.

In this specification, both a product invention and a method invention have been described. The descriptions thereof may be supplementarily applicable, when necessary.

What is claimed is:

1. A display device comprising:
a sensor unit configured to sense an input to the display device;
a display unit configured to display an image;
a communication unit configured to perform communication with an external device; and
a processor configured to control the sensor unit, the display unit and the communication unit,
wherein the processor is further configured to:
detect a touch input of a first input state to the display unit, the first input state being a touch input state detected with the external device worn on a user's body;
detect content displayed by the external device worn on the user's body, the content being displayed at a plurality of executing levels;
detect that the displayed content is first content displayed at a first executing level;
receive, from the external device, second content using the communication unit, the second content being displayed at a second executing level, the second executing level being a lower executing level of the first executing level; and
displays the received second content on the display unit.

2. The display device according to claim 1, further comprising a storage unit configured to store information,
wherein the processor is further configured to:
detect a touch input of a second input state to the display unit, the second input state being a touch input state detected with the external device being unworn on the user's body; and
display the content at a predetermined executing level based on the information stored in the storage unit.

3. The display device according to claim 1, wherein the first executing level comprises at least one second executing level, the second executing level being the lower executing level.

4. The display device according to claim 1, wherein the processor is further configured to make a request to the external device for information related to a wearing state of the external device using the communication unit, receives response information for the request, and detect a state of the touch input based on the received response information.

5. The display device according to claim 4, wherein the external device is a wearable device comprising a wearing sensor unit configured to sense whether the external device is worn on the user's body.

6. The display device according to claim 5, wherein the wearing sensor unit comprises at least one of a touch sensor, a pressure sensor, a camera sensor, a temperature sensor, a biosignal sensor, a motion sensor and an illumination sensor.

7. The display device according to claim 1, wherein the touch input is a touch input to a predetermined region of the display unit.

8. The display device according to claim 7, wherein the predetermined region is a region predetermined by a continuous touch input identifying the region.

9. The display device according to claim 7, wherein, in displaying the second content by detecting the touch input of the first input state to the predetermined region, the processor is further configured to display the second content in the predetermined region.

10. The display device according to claim 1, wherein the processor is further configured to:
detect, when the touch input of the first input state is detected, whether the detected touch input of the first input state is from a right hand or a left hand of the user, using the sensor unit;
display, upon detecting that the touch input of the first input state is from the right hand, the second content on a left side of a position of the detected touch input; and
display, upon detecting that the touch input of the first input state is from the left hand, the second content on a right side of the position of the detected touch input.

11. The display device according to claim 1, wherein the processor is further configured to display, as the second content corresponding to the first content, a content group comprising the first content.

12. The display device according to claim 11, wherein, when the external device worn on the user's body is displaying an image as the first content, the processor is further configured to display an image group comprising the image displayed by the external device as the second content.

13. The display device according to claim 1, wherein, when a plurality of sub-contents are included in the first content, the external device detects a selection input for selecting at least one of the sub-contents,
wherein the processor is further configured to:
receive, as the second content, at least one of the sub-contents selected by the selection input from the external device, using the communication unit; and
display the received second content on the display unit.

14. The display device according to claim 13, wherein, when the first content is a folder and the sub-contents are content executing icons included in the folder, the second content is content corresponding to at least one executing icon selected among the content executing icons by the selection input.

15. The display device according to claim 1, wherein the processor is further configured to display, as the second content corresponding to the first content, a content editing interface configured to edit the first content.

16. The display device according to claim 15, wherein, when the external device worn on the user's body is displaying an image as the first content, the processor is further configured to display an image editing interface for the image displayed by the external device, as the second content.

17. The display device according to claim 15, wherein, when the external device worn on the user's body is displaying a first moving image as the first content, the processor is configured to display, as the second content, a moving image editing interface configured to insert the first moving image into a second moving image displayed on the display unit.

18. The display device according to claim 1, wherein the processor is further configured to, when the processor detects a switch input for switching from the second content displayed on the display unit to third content, switch the displayed second content to the third content according to the detected switch input, and transmit information about the content switching to the external device.

19. The display device according to claim 18, wherein the third content is content displayed at a third executing level, the third executing level being a lower executing level of the second executing level.

20. The display device according to claim 18, wherein, when receiving the switching information, the external device switches the displayed first content to the second content.

21. A method for controlling a display device comprising the steps of:
detecting a touch input of a first input state to a display unit provided to the display device, the first input state being a touch input state detected with the external device worn on a user's body;
detecting content displayed by the external device worn on the user's body, the content being displayed at a plurality of executing levels;
detecting that the displayed content is first content displayed at a first executing level;
receiving, from the external device, second content using the communication unit, the second content being displayed at a second executing level, the second executing level being lower executing level of the first executing level; and
displaying the received second content on the display unit.
